(19) United States
(12) Patent Application Publication
(10) Pub. No.: US 2024/0311778 A1
(43) Pub. Date: Sep. 19, 2024

(54) SYSTEMS AND METHODS FOR EXTENDING DIGITAL PAYMENT NETWORKS

(71) Applicant: Wells Fargo Bank, N.A., San Francisco, CA (US)

(72) Inventor: Lynne Sanders, Charlotte, NC (US)

(21) Appl. No.: 18/183,726

(22) Filed: Mar. 14, 2023

(51) Int. Cl. G06Q 20/10; G06Q 20/22; G06Q 20/36

(52) U.S. Cl. CPC G06Q 20/10; G06Q 20/227; G06Q 20/363

(57) ABSTRACT

Systems, apparatuses, methods, and computer program products are disclosed for extending digital payment networks. An example method includes receiving, from a first device, a digital payment request. The method also includes causing transfer of an amount of funds from an account associated with the sender identifier to a holding account associated with the holding account identifier. The method also includes receiving, from a second device, a digital withdrawal request comprising an entity identifier, a recipient identifier, and a credential. The method also includes verifying, by security circuitry, that the credential is associated with the recipient identifier. The method also includes, in an instance in which the credential is successfully verified, causing transmission of a notification indicating a successful verification of the credential, wherein the successful verification of the credential facilitates an acquisition of physical currency by the target recipient.

### BACKGROUND

Existing digital payment networks exhibit various issues. For example, in order for an individual to use services provided by many digital payment networks, a bank account is required. However, not all individuals have or desire to have a bank account.

### BRIEF SUMMARY

A digital payment network may provide a service that enables individuals to electronically transfer money from their bank account to another registered user's bank account using a mobile device or a website of a participating banking institution. One example of a digital payment network is Zelle®. Digital payment networks provide advantages over existing peer-to-peer (P2P) payment systems (e.g., Cash App, PayPal, etc.) in that digital payment networks allow for instantaneous transfers of money between two bank accounts and instantaneous access to those funds, whereas transfers in P2P payment systems typically involve a settlement period during which funds are unavailable to a payee for some time (e.g., between one and three days). Some P2P payment systems may require users to pay a fee to reduce or eliminate the settlement period. Additionally, digital payment networks employ data encryption technology to protect users and have a digital infrastructure sponsored by major financial institutions. Because digital payment networks (such as Zelle®) transfer funds directly between bank accounts, digital payment networks may be safer option for payments when compared with other online services, such as P2P payment systems, in which funds may be transferred between multiple different platforms.

A drawback of existing digital payment networks (e.g., Zelle®) is that they require users to possess a bank account in order to transfer funds. A Zelle® transaction transfers money from a first bank account directly to a second bank account. In particular, a sender associated with the first bank account creates a Zelle® transfer using his/her bank's mobile application. In creating the Zelle® transfer request, the sender identifies the recipient by phone number or email address (which corresponds to a bank account of the recipient) and adds a transaction amount. Optionally, the sender may add a memo to accompany the transfer (e.g., enabling identification of the purpose of the transfer).

However, a significant number of the global population is unbanked and therefore unable to utilize Zelle® and perform account-to-account transfers. Individuals may be unbanked for a variety of reasons, such as general distrust in banks, a desire for privacy, a familiarity or comfort with a cash-based lifestyle, past transgressions which may impact relationships with banks, and/or other reasons. Nevertheless, these unbanked individuals may benefit from being able to utilize a digital payment network such as Zelle®. As one example, if an unbanked individual needs to be paid for performing a job and the payer does not have cash on hand, the payer is left with little choice but to travel to an Automated Teller Machine (ATM) and/or banking branch to withdraw cash and pay the individual. Alternatively, the payer can pay with a check or through a P2P payment system, both of which delay accessibility of the funds by the unbanked individual, who may also incur fees to receive the funds. These circumstances are inconvenient for both the payer and the unbanked individual; the payer is forced to take additional steps to ensure the individual is paid, and the unbanked individual may be required to wait for the payer to retrieve the cash or be paid at a later time. Further, this may cause strife between the two parties and result in the payer not considering the individual for future jobs.

To resolve existing accessibility issues with Zelle® (and similar digital payment networks) described above, example embodiments described herein provide a backend framework to enable unbanked individuals to participate in Zelle® transactions (e.g., with other banked or unbanked individuals) while remaining unbanked and maintaining a preferred level of privacy. In various embodiments, one or more holding accounts may be established. In some example embodiments, the holding account may be established by a third-party entity, which may, for instance, be an entity with a physical presence in a predefined location (e.g., a location nearby many unbanked individuals). The entity may be a nontraditional financial services entity that is trusted by the unbanked (e.g., a merchant, such as a neighborhood bodega or the like). In some embodiments, unbanked individuals may register with the entity via a secure system in order to provide and/or receive cash through Zelle® by way of the entity. In some embodiments, registration may involve creation of a unique identifier for the unbanked individual. Additionally, the entity (e.g., a merchant) may be pre-registered with Zelle® and/or one or more financial institutions in order to facilitate Zelle® transactions with unbanked individuals.

In various embodiments, to initiate Zelle® transactions, the unbanked individual may identify a Zelle® recipient in the normal fashion, and may provide an identifier for the Zelle® recipient, along with funds (e.g., cash or another source of value) to the entity, which in turn, may accept the funds into an account associated with the entity. The entity may then initiate a Zelle® payment to the recipient identified by the unbanked individual. The entity may, at direction of the unbanked individual, identify the individual as the sender of the funds (e.g., via the memo line).

To receive money via a Zelle® transaction, the unbanked individual may provide a unique identifier, rather than an email address or phone number, to the Zelle® sender. In some embodiments, the unbanked individual may also provide the entity's Zelle® credentials, and the sender can transmit the funds to the entity, listing the unbanked individual's unique number in the memo line. The entity can then receive the funds into its holding account and disambiguate the intended recipient of the funds (e.g., using the memo line). When the unbanked individual arrives, the entity can provide the cash equivalent of the Zelle® transfer amount to the unbanked individual.

In some example embodiments, as further detailed herein, an application that includes an integration layer may be installed by individuals who seek to make Zelle® transfers to unbanked individuals. The application may be installed on a personal device and may be used to auto-populate a Zelle® transfer based on provision of the unbanked individual's unique identifier or a selection of the unbanked individual from a contacts list of the device. In this regard, an unbanked individual may designate a specific entity as their default location for cash retrieval, and a holding account identifier for the entity (and/or, in some embodiments, the unbanked individual's unique identifier) may be automatically populated for all Zelle® transactions concerning the unbanked individual to prevent potential errors when attempt to transfer money to the unbanked individual.

Funds in a holding pen account may be allocated to a plurality of unbanked individuals. If an individual performs a Zelle® transaction, the money may be transferred to or acquired from an entity, such as a neighborhood convenience store or the like, where an individual can collect physical currency.

Accordingly, the present disclosure sets forth systems, methods, and apparatuses that extend a digital payment network to facilitate payments involving unbanked individuals. There are many advantages of the embodiments described herein. For instance, by allowing unbanked individuals to participate in a digital payment network, example embodiments provide a much-needed financial lifeline that would otherwise be unavailable to them. In this regard, an unbanked individual may be enabled to have greater participation in the economy and, at the same time, explore a service previously only available to banked individuals, which may lead the individual to reconsider becoming a banked customer.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 illustrates a system in which some example embodiments may be used for extending a digital payment network.

FIG. 2A illustrates a schematic block diagram of example circuitry embodying a system device that may perform various operations in accordance with some example embodiments described herein.

FIG. 2B illustrates a schematic block diagram of example circuitry embodying a client device that may perform various operations in accordance with some example embodiments described herein.

FIG. 3 illustrates an example flowchart for extending a digital payment network to facilitate a payment to an unbanked individual, in accordance with some example embodiments described herein.

FIG. 4 illustrates an example flowchart for facilitating automatic population of a holding account identifier, in accordance with some example embodiments described herein.

FIG. 5 illustrates an example flowchart for processing a digital withdrawal request, in accordance with some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “computing device” refers to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The term “server” or “server device” refers to any computing device capable of functioning as a server, such as a master exchange server, web server, mail server, document server, or any other type of server. A server may be a dedicated computing device or a server module (e.g., an application) hosted by a computing device that causes the computing device to operate as a server.

### System Architecture

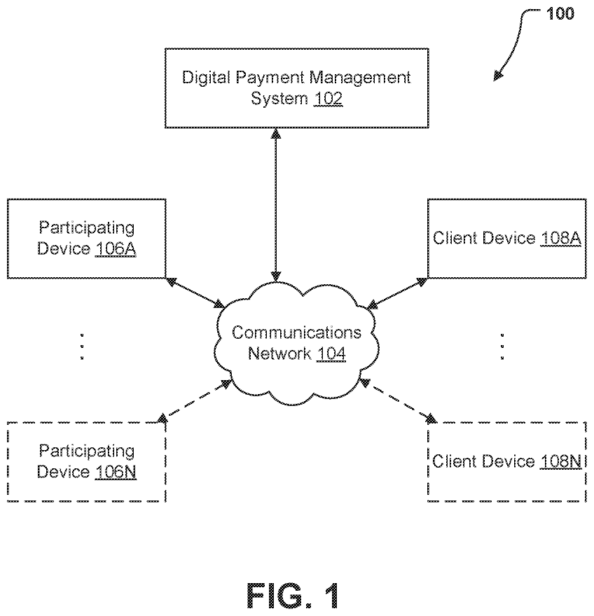

Example embodiments described herein may be implemented using any of a variety of computing devices or servers. To this end, FIG. 1 illustrates an example environment 100 within which various embodiments may operate. As illustrated, a digital payment management system 102 may receive and/or transmit information via communications network 104 (e.g., the Internet) with any number of other devices, such as one or more of participating devices 106A-106N and/or client devices 108A-108N.

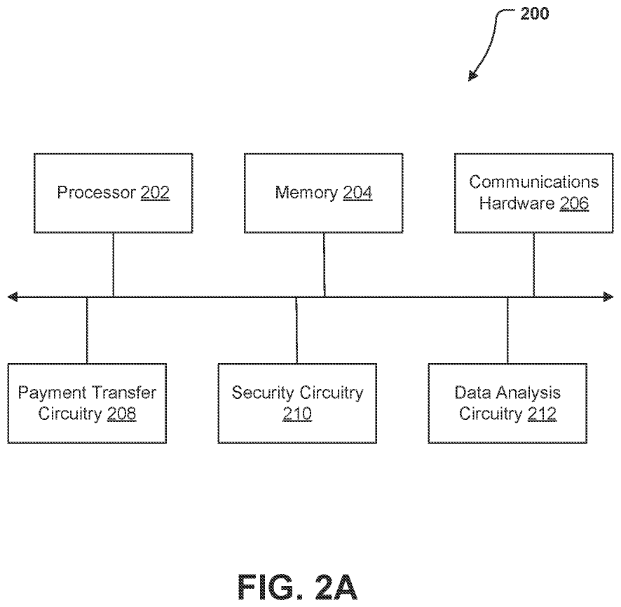

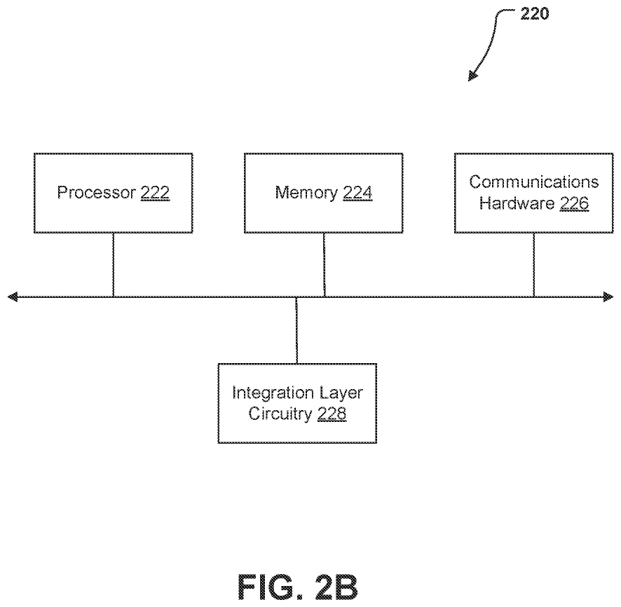

The digital payment management system 102 may be implemented as one or more computing devices or servers, which may be composed of a series of components. Particular components of the digital payment management system 102 are described in greater detail below with reference to apparatus 200 in connection with FIG. 2A.

The one or more participating devices 106A-106N and the one or more client devices 108A-108N may be embodied by any computing devices known in the art. The one or more participating devices 106A-106N and the one or more client devices 108A-108N need not themselves be independent devices, but may be peripheral devices communicatively coupled to other computing devices. In various embodiments, participating devices may comprise devices belonging to an entity (e.g., a merchant), also referred to as entity devices, such as Point of Sale (POS) devices. In some embodiments, participating devices may comprise self-service kiosk devices, e.g., Automated Teller Machines (ATMs) and/or the like. These participating devices 106A-106N may communicate (e.g., via communications network 104) with the digital payment management system, e.g., to process digital withdrawal requests and/or initiate Zelle® transfers, as further detailed herein. In various embodiments, client devices 108A-108N may comprise personal devices (e.g., mobile phones, wearable devices, etc.) belonging to one or more users. For example, a user may utilize their personal client device to initiate a Zelle® transfer via a mobile application installed on the client device.

### Example Implementing Apparatuses

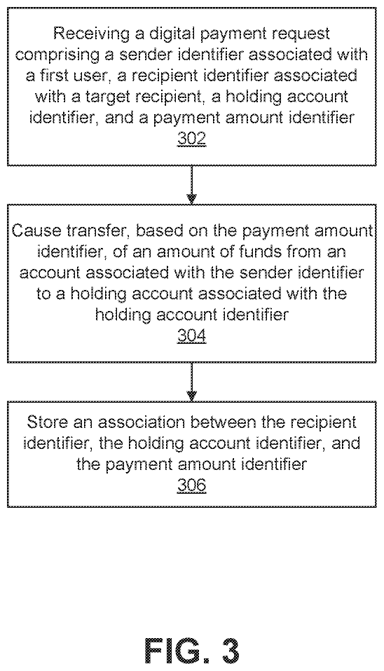

The digital payment management system 102 (described previously with reference to FIG. 1) may be embodied by one or more computing devices or servers, shown as apparatus 200 in FIG. 2A. The apparatus 200 may be configured to execute various operations described above in connection with FIG. 1 and below in connection with FIGS. 3-5. As illustrated in FIG. 2A, the apparatus 200 may include processor 202, memory 204, communications hardware 206, payment transfer circuitry 208, security circuitry 210, and data analysis circuitry 212, each of which will be described in greater detail below.

The processor 202 (and/or co-processor or any other processor assisting or otherwise associated with the processor) may be in communication with the memory 204 via a bus for passing information amongst components of the apparatus. The processor 202 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud” processors, or any combination thereof.

The processor 202 may be configured to execute software instructions stored in the memory 204 or otherwise accessible to the processor. In some cases, the processor may be configured to execute hard-coded functionality. As such, whether configured by hardware or software methods, or by a combination of hardware with software, the processor 202 represent an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

Memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, or the like, for enabling the apparatus to carry out various functions in accordance with example embodiments contemplated herein.

The communications hardware 206 may be any means such as a device or circuitry embodied in either hardware or a combination of hardware and software that is configured to receive and/or transmit data from/to a network and/or any other device, circuitry, or module in communication with the apparatus 200. In this regard, the communications hardware 206 may include, for example, a network interface for enabling communications with a wired or wireless communication network. For example, the communications hardware 206 may include one or more network interface cards, antennas, buses, switches, routers, modems, and supporting hardware and/or software, or any other device suitable for enabling communications via a network. Furthermore, the communications hardware 206 may include the processing circuitry for causing transmission of such signals to a network or for handling receipt of signals received from a network.

The communications hardware 206 may further be configured to provide output to a user and, in some embodiments, to receive an indication of user input. In this regard, the communications hardware 206 may comprise a user interface, such as a display, and may further comprise the components that govern use of the user interface, such as a web browser, mobile application, dedicated client device, or the like. In some embodiments, the communications hardware 206 may include a keyboard, a mouse, a touch screen, touch areas, soft keys, a microphone, a speaker, and/or other input/output mechanisms. The communications hardware 206 may utilize the processor 202 to control one or more functions of one or more of these user interface elements through software instructions (e.g., application software and/or system software, such as firmware) stored on a memory (e.g., memory 204) accessible to the processor 202.

In addition, the apparatus 200 further comprises payment transfer circuitry 208 that causes transfer of funds between two accounts, such as, for example, a sender's account and a holding account, between an entity's account and a recipient's account, between a sender's account and a recipient's account, etc. The payment transfer circuitry 208 may utilize processor 202, memory 204, or any other hardware component included in the apparatus 200 to perform these operations, as described in connection with FIGS. 3-5 below. The payment transfer circuitry 208 may further utilize communications hardware 206 to gather data from a variety of sources (e.g., participating devices 106A-106N and/or client devices 108A-108N, as shown in FIG. 1), and in some embodiments may utilize processor 202 and/or memory 204 to cause transfer of funds between two accounts. The payment transfer circuitry 208 may cause transfer of funds by initiating an Automated Clearing House (ACH) transfer process. In this manner, two accounts (which may be associated with different banks) may be connected via an ACH network. A batch file may be generated that comprises transaction details (e.g., a payment amount, account numbers, routing numbers, etc.) which is then received by the ACH network. The transaction details may be verified by the ACH network and the funds may be credited to the recipient's account through a secure connection. Through ACH, various security measures such as encryption and authentication may be employed to ensure the transfer is compliant with any applicable regulations and protocols.

In addition, the apparatus 200 further comprises security circuitry 210 that verifies a credential associated with an individual based on a stored credential. The security circuitry 210 may utilize processor 202, memory 204, or any other hardware component included in the apparatus 200 to perform these operations, as described in connection with FIGS. 3-5 below. The security circuitry 210 may further utilize communications hardware 206 to gather data from a variety of sources (e.g., participating devices 106A-106N or client devices 108A-108N, as shown in FIG. 1), and/or exchange data with a user, and in some embodiments may utilize processor 202 and/or memory 204 to verify a credential.

Further, the apparatus 200 further comprises data analysis circuitry 212 that identifies amounts of funds and determines whether a requested amount identifier satisfies an amount stored in association with a recipient identifier. The data analysis circuitry 212 may utilize processor 202, memory 204, or any other hardware component included in the apparatus 200 to perform these operations, as described in connection with FIGS. 3-5 below. The data analysis circuitry 212 may further utilize communications hardware 206 to gather data from a variety of sources (e.g., participating devices 106A-106N or client devices 108A-108N, as shown in FIG. 1), and/or exchange data with a user, and in some embodiments may utilize processor 202 and/or memory 204 to identify amounts of funds and determine whether a requested amount identifier satisfies an amount stored in association with a recipient identifier.

Although components 202-212 are described in part using functional language, it will be understood that the particular implementations necessarily include the use of particular hardware. It should also be understood that certain of these components 202-212 may include similar or common hardware. For example, the payment transfer circuitry 208, security circuitry 210, and data analysis circuitry 212 may each at times leverage use of the processor 202. memory 204, or communications hardware 206, such that duplicate hardware is not required to facilitate operation of these physical elements of the apparatus 200 (although dedicated hardware elements may be used for any of these components in some embodiments, such as those in which enhanced parallelism may be desired). Use of the term “circuitry” with respect to elements of the apparatus therefore shall be interpreted as necessarily including the particular hardware configured to perform the functions associated with the particular element being described. Of course, while the term “circuitry” should be understood broadly to include hardware, in some embodiments, the term “circuitry” may in addition refer to software instructions that configure the hardware components of the apparatus 200 to perform the various functions described herein.

Although the payment transfer circuitry 208, security circuitry 210, and data analysis circuitry 212 may leverage processor 202, memory 204, or communications hardware 206 as described above, it will be understood that any of payment transfer circuitry 208, security circuitry 210, and data analysis circuitry 212 may include one or more dedicated processor, specially configured field programmable gate array (FPGA), or application specific interface circuit (ASIC) to perform its corresponding functions, and may accordingly leverage processor 202 executing software stored in a memory (e.g., memory 204), or communications hardware 206 for enabling any functions not performed by special-purpose hardware. In all embodiments, however, it will be understood that payment transfer circuitry 208, security circuitry 210, and data analysis circuitry 212 comprise particular machinery designed for performing the functions described herein in connection with such elements of apparatus 200.

As illustrated in FIG. 2B, an apparatus 220 is shown that represents an example client device (e.g., any of client devices 108A-108N). The apparatus 220 includes processing circuitry 222, memory 224, and communications hardware 226, each of which is configured to be similar to the similarly named components described above in connection with FIG. 2A. However, the apparatus 220 also includes integration layer circuitry 228, which may be integrated into a predefined application (e.g., a mobile banking application) and which can retrieve data from one or more applications stored (e.g., in memory 224) on a client device and generate requests comprising the retrieved data (e.g., contact information for a particular contact and/or other information).

In some embodiments, the integration layer circuitry 228 may utilize an Application Programming Interface (API) to connect to one or more applications. For example, the integration layer circuitry 228 may utilize an API to connect to a contacts application that stores a contacts list. The integration layer circuitry 228, via the API, can cause display of the contacts list within the predefined application, thus enabling a user to select a contact from the contacts list. Once a contact is selected, the integration layer circuitry 228, via the API, may retrieve contact information for the selected contact (e.g., a phone number, email address, or the like). The integration layer circuitry 228 may then generate a request comprising the retrieved contact information, which can then be transmitted to the digital payment management system 102 to identify additional information based on the contact information (e.g., a recipient identifier and/or a holding account identifier associated with the contact information). The integration layer circuitry 228 may utilize processor 222, memory 224, or any other hardware component included in the apparatus 220 to perform these operations. The integration layer circuitry 228 may further utilize communications hardware 226 to cause transmission of requests to the digital payment management system 102.

In some embodiments, various components of the apparatuses 200 and 220 may be hosted remotely (e.g., by one or more cloud servers) and thus need not physically reside on the corresponding apparatus 200 or 220. For instance, some components of the apparatus 200 may not be physically proximate to the other components of apparatus 200. Similarly, some or all of the functionality described herein may be provided by third party circuitry. For example, a given apparatus 200 may access one or more third party circuitries in place of local circuitries for performing certain functions.

As will be appreciated based on this disclosure, example embodiments contemplated herein may be implemented by an apparatus 200 or 220. Furthermore, some example embodiments may take the form of a computer program product comprising software instructions stored on at least one non-transitory computer-readable storage medium (e.g., memory 204). Any suitable non-transitory computer-readable storage medium may be utilized in such embodiments, some examples of which are non-transitory hard disks, CD-ROMs, DVDs, flash memory, optical storage devices, and magnetic storage devices. It should be appreciated, with respect to certain devices embodied by apparatus 200 as described in FIG. 2A or apparatus 220 as described in FIG. 2B, that loading the software instructions onto a computing device or apparatus produces a special-purpose machine comprising the means for implementing various functions described herein.

Having described specific components of example apparatuses 200 and 220, example embodiments are described below in connection with a series of flowcharts.

### Example Operations

Turning to FIGS. 3-5, example flowcharts are illustrated that contain example operations implemented by example embodiments described herein. The operations illustrated in FIGS. 3-5 may, for example, be performed by a system device of the digital payment management system 102 shown in FIG. 1, which may in turn be embodied by an apparatus 200, which is shown and described in connection with FIG. 2A. To perform the operations described below, the apparatus 200 may utilize one or more of processor 202, memory 204, communications hardware 206, payment transfer circuitry 208, security circuitry 210, data analysis circuitry 212, and/or any combination thereof. It will be understood that user interaction with the digital payment management system 102 may occur directly via communications hardware 206, or may instead be facilitated by a separate client device 108A-108N or participating device 106A-106N, as shown in FIG. 1, and which may have similar or equivalent physical componentry facilitating such user interaction.

In some embodiments, an unbanked individual may register with Zelle® (or similar digital payment network) in order to acquire a unique identifier that identifies themselves as a party in a Zelle® transaction. Traditionally, one could use their email address or phone number to identify themselves as a party in a Zelle® transaction. However, an unbanked individual may desire added privacy (e.g., based on a distrust in the banking sector) and therefore may not want their email address (which could potentially expose their name) or phone number to be associated with Zelle®. In this regard, the unbanked individual may participate in a registration process with Zelle® in which a unique identifier not associated with any personal identifying information (PII) is generated for the individual. To do so, in some embodiments, the individual may register via a mobile application installed on their personal client device (e.g., a Zelle® app or the like).

In some embodiments, the unique identifier may be based on a number, code (e.g., an alphanumeric string), or other identifier associated with the individual which does not reveal the identity of the individual. For example, in some embodiments, the unique identifier may be generated based on an identifier that is associated with a device belonging to or otherwise associated with the individual. For instance, in some embodiments, a unique identifier may be generated based on a Media Access Control (MAC) address associated with a personal client device belonging to the individual. In some embodiments, for example, the unique identifier may comprise a one-way hash of the MAC address. In this manner, it can be ensured that the individual's unique identifier for Zelle® is unique to the individual (due to MAC addresses being globally unique), while also limiting exposure of their MAC address (e.g., via the hash).

In some embodiments, during registration, an individual may also create a credential associated with their unique identifier. For example, a credential may comprise a Personal Identification Number (PIN). In some embodiments, a credential may comprise a biometric marker of the individual. For example, the individual may provide a fingerprint (or other biometric) via the Zelle® app during registration such that the unique identifier is stored in association with the submitted credential. In this regard, the apparatus 200 includes means, such as processor 202, memory 204, communications hardware, or the like, for storing a unique identifier in association with a credential. As further discussed herein, stored credential may be verified each time the individual wishes to withdraw cash received in a Zelle® transfer.

In some embodiments, during registration, an individual may also provide various identifying information if they so wish. For instance, the individual may provide contact information, such as their phone number and/or email address, and this information may be stored in association with their unique identifier. For instance, as discussed above and further detailed below, providing contact information such as a phone number may be beneficial in that another individual may select the individual from a contacts list (e.g., stored on their personal client device) when generating a Zelle® transfer, and the transfer request may be automatically populated with their unique identifier (and/or holding account identifier) associated with the contact information (e.g., phone number) of the individual. This avoids a situation in which the individual may mistype the unique identifier or holding account identifier and potentially transfer money to the wrong individual and/or entity.

In some embodiments, unique identifiers may be issued via physical cards (e.g., similar to credit/debit cards). For instance, individuals may purchase a card already associated with a unique identifier from a store. The individual may then register the card online (e.g., through a Zelle® app or the like) and create a credential to be associated with the card. In this manner, an individual can present the card when participating in a Zelle® transfer (e.g., when attempting to send money or withdraw money) in order to provide their unique identifier and/or other information needed for the transfer.

In some embodiments, during registration, the individual may also specify a preferred holding account identifier that identifies an account in which they would prefer any money transferred to them be held until they are able to withdraw the money. For example, various entities (e.g., merchants) may register with Zelle® and open a dedicated holding account associated with their business, which may be separate from other entity accounts (e.g., business accounts) associated with the entity and instead dedicated to holding money for individuals involved in Zelle® transfers. By doing so, the entity may be pre-registered to facilitate Zelle® transactions from within their establishments (e.g., locations such as retail stores, restaurants, convenience stores, bodegas, and/or the like) such that the entity can disburse funds in connection with the holding account to individuals. For example, the individual may specify a holding account identifier associated with a place that they trust and are familiar with, such as their neighborhood convenience store. In this regard, any Zelle® transfers directed to the individual may be directed to a holding account associated with the convenience store, such that the individual can withdraw money by visiting the convenience store. In this regard, withdrawal activity may be limited to a specific location (e.g., the convenience store) to increase fraud prevention. For instance, personnel of the convenience store may become familiar with the individual consistently visiting the convenience store to withdraw cash from Zelle® transfers, and therefore may more readily identify an imposter attempting to use the individual's credentials to withdraw cash at the convenience store. In various embodiments, entities may be enticed to participate in facilitating Zelle® transfers as they may increase foot traffic in their locations (e.g., individuals entering to withdraw money may also make purchases while inside).

In some embodiments, the digital payment management system 102 may comprise its own holding account, or a “global” holding account which may enable an individual to withdraw money at a location of any participating entity that enables Zelle® transfers and withdrawals. In this regard, when a user requests a Zelle® withdrawal at a participating location, funds from the global holding account may be directly transferred (e.g., via Zelle®) to an entity account associated with the entity. The entity may then provide the individual with physical currency (e.g., cash) in response to the transfer. In some embodiments, if an individual does not specify a desired holding account identifier during registration, a holding account identifier associated with the global holding account may be automatically associated with their unique identifier as the default choice.

FIG. 3 shows example operations for extending a digital payment network to facilitate a payment to an unbanked individual. In particular, the operations shown in FIG. 3 may be carried out in response to a banked individual (e.g., an individual having a bank account) requesting to send money via Zelle® to an unbanked individual (e.g., an individual not having a bank account). In some embodiments, a banked individual may generate a digital payment request and cause transmission of the digital payment request to the digital payment management system 102 via their personal client device (e.g., client device 108A). In this regard, as shown in operation 302, the apparatus 200 includes means, such as processor 202, memory 204, communications hardware 206, or the like, for receiving, from a first device, a digital payment request comprising a sender identifier associated with a first user, a recipient identifier associated with a target recipient, a holding account identifier, and a payment amount identifier. For example, the sender identifier may identity the banked individual (the individual that is generating the digital payment request to transfer money). The recipient identifier may identify a target (e.g., intended) recipient, who may be an unbanked individual. The holding account identifier may identify a holding account which the payment may be routed to, as further discussed below. The holding account identifier may identify an account number, and in some embodiments, also a routing number for the holding account. The payment amount identifier may identify an amount of money which the sender intends to transfer to the recipient.

The banked individual (e.g., the sender) may initiate a digital payment request (e.g., a Zelle® transfer) in a traditional manner, e.g., through a mobile banking app installed on their personal device. The banked individual may specify a recipient identifier, e.g., the unique identifier of the target recipient (the unbanked individual) in the digital payment request. For instance, the unbanked individual may have provided their unique identifier to the banked individual at an earlier time, and the banked individual may manually enter the unique identifier. In some embodiments, an application (e.g., a mobile banking application) may be installed on the unbanked individual's client device that enables various information for a digital payment request to be automatically populated during generation of the digital payment request. In some embodiments, the application may include an integration layer configured to retrieve information from one or more additional applications installed on the user's device. For example, in some embodiments, the integration layer may allow for the banked individual, via the mobile banking application, to select the unbanked individual from a contact list of a contacts application, and the associated contact information may then be processed to identify an appropriate recipient identifier. In this regard, the apparatus 220 includes means, such as processor 222, memory 224, integration layer 228, or the like, for receiving contact data based on a selection, via a first application, of a first contact associated with a second application. For instance, in some embodiments, upon selection of a contact from a contact list (e.g., a contact list from a contacts application or other application installed on the device) displayed via a mobile banking application, a request from the client device may be generated transmitted to the digital payment management system 102 to automatically populate information (e.g., a recipient identifier and/or a holding account identifier) associated with that contact. In this regard, the apparatus 220 includes means, such as processor 222, memory 224, integration layer circuitry 228, or the like, for generating a request comprising contact data. The apparatus 220 also includes means, such as processor 222, memory 224, communications hardware 226, or the like, for causing transmission of the request comprising contact data (e.g., to digital payment management system 102). In this regard, the digital payment management system 102 may receive a request containing contact information for that particular contact. In this regard, the apparatus 200 includes means, such as processor 202, memory 204, communications hardware 206, or the like, for receiving a request comprising contact information. For example, the request may comprise a phone number or email address for the selected contact.

The digital payment management system 102 may then query one or more databases with the contact information to retrieve a unique identifier stored in association with that contact information. In this regard, the apparatus 200 includes means, such as processor 202, memory 204, data analysis circuitry 212, or the like, for determining a recipient identifier based on contact information. The digital payment management system 102 may then cause transmission of a response comprising the recipient identifier to the client device to facilitate an automatic population of a digital payment request with the recipient identifier. In this regard, the apparatus 200 includes means, such as processor 202, memory 204, communications hardware 206, or the like, for causing transmission of a response comprising a recipient identifier to facilitate an automatic population of the digital payment request with the recipient identifier. In some embodiments, the response may additionally include other information which can be automatically populated into the digital payment request, such as a holding account identifier, further discussed below.

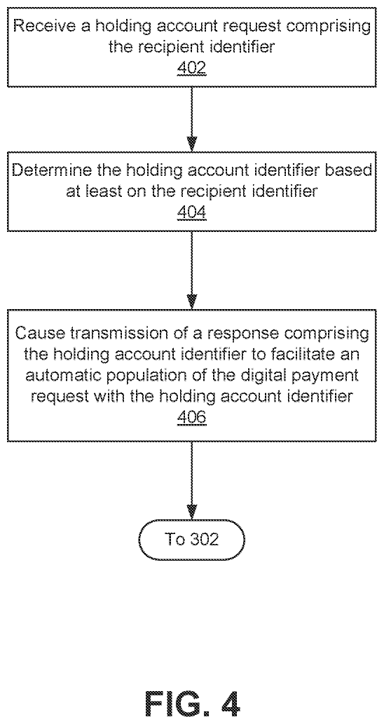

In some embodiments in which the sender manually enters a unique identifier, the sender may also manually enter a holding account identifier. For example, the target recipient (e.g., an unbanked individual) may have provided the holding account identifier to the banked individual at an earlier time, and the banked individual may manually enter the holding account identifier. In some embodiments, however, the holding account identifier may be automatically populated in response to the sender entering the recipient identifier into the digital payment request. For example, turning to FIG. 4, example operations are shown for facilitating automatic population of a holding account identifier.

As shown by operation 402, the apparatus 200 includes means, such as processor 202, memory 204, communications hardware 206, or the like, for receiving, in connection with a generation of the digital payment request at a client device, a holding account request comprising the recipient identifier. In some embodiments, the holding account request may be automatically generated and transmitted to the digital payment management system 102 in response to the sender entering a recipient identifier into a digital payment request at their client device.

As shown by operation 404, the apparatus 200 includes means, such as processor 202. memory 204, data analysis circuitry 212, or the like, for determining, by data analysis circuitry, the holding account identifier based at least on the recipient identifier. For example, the digital payment management system 102 may query one or more databases with the recipient identifier to retrieve a holding account identifier stored in association with that contact information.

As shown by operation 406, the apparatus 200 includes means, such as processor 202. memory 204, communications hardware 206, or the like, for causing transmission of a response comprising the holding account identifier. The transmission of the response facilitates an automatic population of the digital payment request with the holding account identifier. In this regard, potential for human error when attempting to manually enter a holding account identifier is avoided by automatically populating the digital payment request with the correct holding account identifier.

The response may be received at the client device and processed to automatically populate a digital payment request with information contained in the response (e.g., a recipient identifier and/or holding account identifier. In this regard, the apparatus 220 includes means, such as processor 222, memory 224, communications hardware 226, or the like, for receiving a response comprising one or more identifiers. The apparatus 220 also includes means, such as processor 222, memory 224, integration layer circuitry 228, or the like, for automatically populating a digital payment request based on the response. The banked individual, via their client device, may then confirm all details regarding their Zelle® transfer and execute the transfer, which comprises sending the digital payment request to the digital payment management system 102 for further processing. In this regard, the apparatus 220 includes means, such as processor 222, memory 224, communications hardware 226, or the like, for causing transmission of a digital payment request.

In some embodiments, the integration layer circuitry 228 may automatically retrieve information (e.g., from the digital payment management system 102) for all contacts (e.g., all contacts who have established a unique identifier for Zelle® transfers) and store that information locally on the client device (e.g., in memory 224). In this manner, network and computational resources may be preserved in that a request for identifier information may not need to be transmitted each time a contact is selected from a contacts list for a digital payment request. Instead, the integration layer circuitry 228 may retrieve the appropriate identifier locally (e.g., from memory 224). In some embodiments, the integration layer circuitry 228 may regularly retrieve and store identifier information from the digital payment management system 102 in order to keep any locally stored identifier information up to date.

Returning to FIG. 3, once a digital payment request is received by the digital payment management system 102, a transfer of funds from the sender's account to the holding account specified by the digital payment request may be completed. As shown by operation 304, the apparatus 200 includes means, such as processor 202, memory 204, payment transfer circuitry 208, or the like, for causing transfer, based on the payment amount identifier, of an amount of funds from an account associated with the sender identifier to a holding account associated with the holding account identifier. In this regard, funds in an amount identified by the payment amount identifier are transferred from the sender's account to the designated holding account.

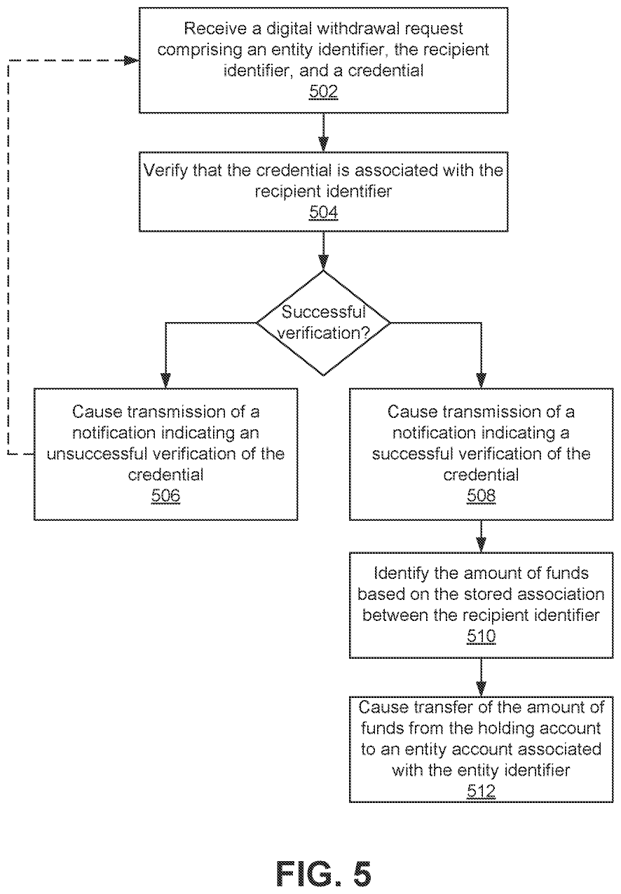

As shown by operation 306, the apparatus 200 includes means, such as processor 202, memory 204, communications hardware 206, or the like, for storing an association between the recipient identifier, the holding account identifier, and the payment amount identifier. This stored association can later be analyzed (as discussed in connection with FIG. 5 below) when a digital withdrawal request is received by the digital payment management system 102.

Turning to FIG. 5, example operations are shown for processing a digital withdrawal request. In some embodiments, as discussed above, a recipient (e.g., an unbanked individual) may collect cash received in a Zelle® transfer from one or more entities (e.g., merchants). To do so, the recipient may provide their unique identifier (e.g., the recipient identifier) and credential via a device associated with the entity. For example, a user may enter their neighborhood convenience store and interact directly (or indirectly via a clerk) with a device to provide their unique identifier and credential. In some embodiments, the unique identifier may be provided via a physical card as described above (e.g., the card may be swiped, and the entity device may obtain the unique identifier digitally via the swipe). The individual may also request a specific amount to withdraw in cash. For example, the individual may have been involved with numerous Zelle® transfers over the course of the day, and may desire to only withdraw a certain amount of money rather than all money received from the transfers. In some embodiments, when an amount is not specified, the individual may withdraw all funds associated with their unique identifier in the holding account. In some embodiments, the device from which a digital withdrawal request is initiated may comprise an ATM or similar kiosk device which a user can use to withdraw (or send) money via a Zelle® transfer. In some embodiments, the user may provide their credential via an input device (e.g., number pad in the case of a PIN or a biometric reader in the case of a biometric credential) associated with the entity device.

Once generated, a digital withdrawal request may be transmitted to the digital payment management system 102 for further processing. As shown by operation 502, the apparatus 200 includes means, such as processor 202, memory 204, communications hardware 206, or the like, for receiving, from a second device (e.g., an entity device), a digital withdrawal request comprising an entity identifier, the recipient identifier, and a credential.

The digital payment management system 102 may then verify the credential upon receiving the digital withdrawal request. In this regard, as shown in operation 504, the apparatus 200 includes means, such as processor 202, memory 204, security circuitry 210, or the like, for verifying that the credential is associated with the recipient identifier. In some embodiments, the verification may involve comparing the credential with a stored credential associated with the recipient identifier. For example, the digital payment management system 102 may verify that the credential submitted with the digital withdrawal request matches a stored credential associated with the recipient identifier.

In some embodiments, such as instances in which the credential is a biometric marker (e.g., a fingerprint), the digital payment management system 102 may confirm that the submitted credential shares enough similarities to a stored biometric marker to satisfy a predefined similarity threshold. For example, the security circuitry 210 may preprocess the submitted biometric marker (e.g., to remove noise, inconsistencies, or the like) and compare the preprocessed biometric marker to the stored biometric marker using a matching algorithm, such as minutiae-based matching or pattern matching. A resulting match score may then be compared with a predefined similarity threshold. In some embodiments, if the match score exceeds the predefined similarity threshold, the credential may be successfully verified.

In some embodiments, a third-party verification service may be utilized to determine that the submitted credential is associated with the recipient identifier. In some embodiments, the verification may involve generating (e.g., by a third-party service) a one-time password, challenge/response token, or the like, and transmitting to the individual associated with the recipient identifier, such as via a device by way of a text message, email, or the like. In this regard, a correct response submitted by the individual from their personal device may verify the credential.

As shown in FIG. 5, if the credential cannot be successfully verified, the method may continue to operation 506, wherein the apparatus 200 includes means, such as processor 202, memory 204, communications hardware 206, or the like, for causing transmission of a notification indicating an unsuccessful verification of the credential. The notification may be transmitted back to the entity device from which the digital withdrawal request originated. In this regard, the notification may prompt the user to resubmit their credential (e.g., due to a mistyping of a PIN or bad reading of a biometric).

In response to a successful verification of the credential, the method may continue to operation 508, wherein the apparatus 200 includes means, such as processor 202, memory 204, communications hardware 206, or the like, for causing transmission of a notification indicating a successful verification of the credential. The notification may be transmitted back to the entity device from which the digital withdrawal request originated. In some embodiments, the notification may prompt the individual (or, e.g., a store clerk facilitating the interaction with the individual) to confirm details of the withdrawal, such as a requested amount or the like. Upon confirmation, a transfer from the holding account to an entity account associated with the entity identifier may take place. In this regard, a successful verification of the credential facilitates an acquisition of physical currency by the target recipient.

At operation 510, the apparatus 200 includes means, such as processor 202, memory 204, data analysis circuitry 212, or the like, for identifying an amount of funds based on the stored association between the recipient identifier, the holding account identifier, and the payment amount identifier. In this regard, the digital payment management system 102 may confirm that the funds requested via the digital withdrawal request are equal to or less than an amount of funds associated with the recipient identifier.

Once confirmed, a transfer from the holding account to the entity account may take place. In this regard, as shown by operation 512, the apparatus 200 includes means, such as processor 202, memory 204, payment transfer circuitry 208, or the like, for causing transfer of the amount of funds from the holding account to an entity account associated with the entity identifier. In this regard, the entity account is credited with the amount of funds specified by the digital withdrawal request. In some embodiments, cash in the amount specified by the digital withdrawal request may then be provided to the unbanked individual. For example, a store clerk may provide the cash directly to the individual. In some embodiments, e.g., when the individual is utilizing a kiosk device such as an ATM, the cash may be automatically dispensed to the individual.

FIGS. 3-5 illustrate operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be implemented by execution of software instructions. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a non-transitory computer-readable memory that may direct a computing device or other programmable apparatus to function in a particular manner, such that the software instructions stored in the computer-readable memory comprise an article of manufacture, the execution of which implements the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices which perform the specified functions, or combinations of special purpose hardware and software instructions.

### Conclusion

As described above, example embodiments provide methods and apparatuses that extend a digital payment network to incorporate a backend framework that facilitates payments involving unbanked individuals. Example embodiments thus provide tools that overcome existing issues present in digital payment networks (such as Zelle®) today. For example, by enabling automatic population of certain identifiers in a digital payment request, example embodiments thus save time and resources, while also eliminating the possibility of human error that may lead to an incorrect (and potentially irreversible) payment. Additionally, the embodiments presented herein also help reduce or eliminate the need for unbanked individuals to rely on expensive and risky informal lending sources, which often lead to a cycle of debt that is difficult to escape. Therefore, example embodiments offer a crucial solution to the problem of financial inclusion and may improve the financial well-being of millions of unbanked individuals around the world.

As these examples all illustrate, example embodiments contemplated herein provide technical solutions that solve real-world problems faced by existing digital payment networks. And while solutions around financial inclusion have been an issue for decades, the recently exploding amount of data and new financial technologies today has made this problem significantly more acute, as many banked individuals and businesses are increasingly less reliant on physical currency (e.g., cash), while the unbanked remain perhaps more reliant than ever. At the same time, the recently arising ubiquity of secure authentication mechanisms and payment technologies has unlocked new avenues to solving this problem that historically were not available, and example embodiments described herein thus represent a technical solution to these real-world problems.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
receiving, by communications hardware and from a first device, a digital payment request comprising a sender identifier associated with a first user, a recipient identifier associated with a target recipient, a holding account identifier, and a payment amount identifier;
causing transfer, by payment transfer circuitry and based on the payment amount identifier, of an amount of funds from an account associated with the sender identifier to a holding account associated with the holding account identifier;
storing, by the communications hardware, an association between the recipient identifier, the holding account identifier, and the payment amount identifier;
receiving, by the communications hardware and from a second device, a digital withdrawal request comprising an entity identifier, the recipient identifier, and a credential;
verifying, by security circuitry, that the credential is associated with the recipient identifier, and
in an instance in which the credential is successfully verified:
causing transmission, by the communications hardware, of a notification indicating a successful verification of the credential, wherein the successful verification of the credential facilitates an acquisition of physical currency by the target recipient.

2. The method of claim 1, further comprising, in the instance in which the credential is successfully verified:
identifying, by the payment transfer circuitry, the amount of funds based on the stored association between the recipient identifier.

3. The method of claim 2, further comprising, in the instance in which the credential is successfully verified:
causing transfer, by the payment transfer circuitry, of the amount of funds from the holding account to an entity account associated with the entity identifier.

4. The method of claim 3, wherein the entity identifier identifies a merchant, and wherein the merchant is pre-registered to facilitate disbursement of funds in connection with the holding account.

5. The method of claim 1, wherein in an instance in which the credential is unable to be verified, the method further comprises:
causing transmission, by the communications hardware, a notification indicating an unsuccessful verification of the credential.

6. The method of claim 1, wherein the digital withdrawal request further comprises a requested amount identifier, and the method further comprises:
determining, by the payment transfer circuitry, whether the requested amount identifier satisfies an amount stored in association with the recipient identifier.

7. The method of claim 1, wherein the target recipient is an unbanked individual.

8. The method of claim 1, further comprising, prior to receiving the digital payment request:
receiving, by the communications hardware and in connection with a generation of the digital payment request at a client device, a holding account request comprising the recipient identifier;
determining, by data analysis circuitry, the holding account identifier based at least on the recipient identifier; and
causing transmission, by the communications hardware, of a response comprising the holding account identifier, wherein the transmission of the response facilitates an automatic population of the digital payment request with the holding account identifier.

9. An apparatus comprising:
communications hardware configured to receive, from a first device, a digital payment request comprising a sender identifier associated with a first user, a recipient identifier associated with a target recipient, a holding account identifier, and a payment amount identifier; and
payment transfer circuitry configured to cause transfer, based on the payment amount identifier, of an amount of funds from an account associated with the sender identifier to a holding account associated with the holding account identifier,
wherein the communications hardware is further configured to:
store an association between the recipient identifier, the holding account identifier, and the payment amount identifier; and
receive, from a second device, a digital withdrawal request comprising an entity identifier, the recipient identifier, and a credential,
wherein the apparatus further comprises security circuitry configured to verify that the credential is associated with the recipient identifier,
wherein the communications hardware is further configured to, in an instance in which the credential is successfully verified, cause transmission of a notification indicating a successful verification of the credential, wherein the successful verification of the credential facilitates an acquisition of physical currency by the target recipient.

10. The apparatus of claim 9, wherein the payment transfer circuitry is further configured to, in the instance in which the credential is successfully verified:
identify the amount of funds based on the stored association between the recipient identifier.

11. The apparatus of claim 10, wherein the payment transfer circuitry is further configured to in the instance in which the credential is successfully verified:
cause transfer of the amount of funds from the holding account to an entity account associated with the entity identifier.

12. The apparatus of claim 11, wherein the entity identifier identifies a merchant, and wherein the merchant is pre-registered to facilitate disbursement of funds in connection with the holding account.

13. The apparatus of claim 9, wherein the communications hardware is further configured to, in an instance in which the credential is unable to be verified:
cause transmission a notification indicating an unsuccessful verification of the credential.

14. The apparatus of claim 9, wherein the digital withdrawal request further comprises a requested amount identifier, and the payment transfer circuitry is further configured to:
determine whether the requested amount identifier satisfies an amount stored in association with the recipient identifier.

15. The apparatus of claim 9, wherein the target recipient is an unbanked individual.

16. The apparatus of claim 9, wherein the communications hardware is further configured to, prior to receiving the digital payment request, receive, in connection with a generation of the digital payment request at a client device, a holding account request comprising the recipient identifier,
wherein the apparatus further comprises data analysis circuitry configured to determine the holding account identifier based at least on the recipient identifier, and
wherein the communications hardware is further configured to cause transmission of a response comprising the holding account identifier, wherein the transmission of the response facilitates an automatic population of the digital payment request with the holding account identifier.

17. A computer program product comprising at least one non-transitory computer-readable storage medium storing software instructions that, when executed, cause an apparatus to:
receive, from a first device, a digital payment request comprising a sender identifier associated with a first user, a recipient identifier associated with a target recipient, a holding account identifier, and a payment amount identifier;
cause transfer, based on the payment amount identifier, of an amount of funds from an account associated with the sender identifier to a holding account associated with the holding account identifier;
store an association between the recipient identifier, the holding account identifier, and the payment amount identifier;
receive, from a second device, a digital withdrawal request comprising an entity identifier, the recipient identifier, and a credential;
verify that the credential is associated with the recipient identifier, and
in an instance in which the credential is successfully verified:
cause transmission of a notification indicating a successful verification of the credential, wherein the successful verification of the credential facilitates an acquisition of physical currency by the target recipient.

18. The computer program product of claim 17, wherein the software instructions, when executed, further cause the apparatus to, in the instance in which the credential is successfully verified:
cause transfer of the amount of funds from the holding account to an entity account associated with the entity identifier.

19. The computer program product of claim 18, wherein the entity identifier identifies a merchant, and wherein the merchant is pre-registered to facilitate disbursement of funds in connection with the holding account.

20. The computer program product of claim 17, wherein the target recipient is an unbanked individual.
